(19) United States
(12) Patent Application Publication
(10) Pub. No.: US 2021/0091568 A1
(43) Pub. Date: Mar. 25, 2021

(54) DEVICE AND SYSTEM FOR, AND METHOD OF, CONTROLLING ELECTRICAL DEVICES ACCORDING TO TRANSIENT ENERGY DEMANDS

(71) Applicant: WIREBUTTER PTY LTD, Mount Waverley (AU)

(72) Inventor: Anthony Salerno, Montmorency (AU)

(21) Appl. No.: 16/954,856

(22) PCT Filed: Dec. 19, 2018
(86) PCT No.: PCT/AU2018/000265

§ 371 Date: Jun. 17, 2020

(30) Foreign Application Priority Data
Dec. 19, 2017 (AU) 2017905075

(51) Int. Cl. H02J 3/14; G05B 13/02; H02J 13/00

(52) U.S. Cl. CPC H02J 3/144; G05B 13/021; H02J 13/00026; H02J 13/00016; H02J 2310/14; H02J 13/00001; H02J 13/00034; H02J 13/00002

(57) ABSTRACT

An electrical power consumption control unit that controls power consumed by one or more electrical devices connected thereto including a computer processor having a memory operably connected thereto storing computer instruction code, the unit further including a communication module operable to receive control signals from a remotely located energy manager requesting modification of power consumed by the one or more connected electrical devices, a monitoring module operable to monitor power consumed by the one or more connected electrical devices, and wherein the computer instruction code, when executed by the computer processor, causes the computer processor to control the supply of electrical power to the one or more connected electrical devices, and transmit one or more notifications to the remotely located energy manager regarding the power consumed by the one or more connected electrical devices.

### FIELD OF THE INVENTION

The present invention relates to a device, system and/or method for managing the energy consumption of one or more devices that consume electrical power, for example, water heaters, pool pumps or air conditioners, to enable power consumed by the one or more devices to be decreased, or increased, by a remotely located management entity in accordance with varying energy demands experienced during the day and/or throughout the year.

### BACKGROUND OF THE INVENTION

Power stations and associated infrastructure are increasingly incapable of coping with extreme peak energy demands that are normally observed during summer periods due to, for example, use of air conditioners by the majority of the population in regions in which temperatures approach, or exceed, 30-35° C. (86° F.-95° F.). Such peak energy demand events (sometimes known as “spikes”) are relatively infrequent, and are estimated to occur for a few hours during the day (typically between 4 pm to 8 pm) and only on relatively few days in the year.

Despite the infrequent occurrence of energy demand spikes, they are problematic when they occur and active management of power consumption is required to avoid households, hospitals and/or businesses in a region and/or location being subjected to selective isolation from the power grid in order to manage peak energy demand events. Such isolation from a power grid is commonly known as a “blackout”.

At best, blackouts may be considered an annoyance by residential energy consumers as a result of being left without power for a few hours per day. At worst, blackouts can lead to loss of revenue for businesses and still worse, loss of life of individuals who require power in order to operate critical life-saving equipment such as, for example, heart monitors and dialysis machines.

Additionally, whilst power grids in developed countries are relatively consistent with their power supply, energy grids in developing countries are often less consistent with their power supply and consumers can often experience several blackouts per week or during a single day, even in the absence of any peak energy demands. To address this issue, cities with dense populations within developing countries tend to rely on generators, which, when activated on a mass scale during a blackout, tend to create significant pollution.

It is also estimated that the capacity of power stations and associated infrastructure in developed countries is under-utilized for the majority of the year leading to loss of revenue for energy generators and suppliers. The loss of revenue is primarily due to building and maintaining large and/or additional power installations in an attempt to cope with transient peak energy demands.

Renewable sources of energy such as, for example solar, wind, geothermal and hydroelectric power, are increasingly gaining in popularity since such forms of energy production are collected and/or produced from renewable resources and are therefore considered to have less impact on the environment. However, many forms of renewable energy are not without environmental impact and have associated barriers including commercialization and market barriers. Many forms of renewable energy are also presently unreliable and therefore are not presently able to compete with conventional forms of energy including energy derived from coal, oil and natural gas.

In an effort to address these problems, energy suppliers and/or retailers in developed countries offer consumers incentives (usually in the form of rebates) to switch off non-essential electrical devices (appliances or other loads) during peak energy consumption periods which is intended to decrease power consumption during those times of the year during which peaks in the demand for energy are typically experienced and/or expected to occur. The protocol implemented is sometimes referred to as Demand Response Management or DRM.

As part of the initiative to reduce overall power consumption during peak periods, electrical appliances such as air conditioners, have integrated DRM circuitry that enables the power consumed by the air conditioner compressor to be reduced, for example, to 75% or 50% the maximum load of the appliance by remote control. In this regard, many energy retailers remotely trigger a “demand enabled response” in order to reduce the power consumed by consumer appliances as required to cope with the peak energy demand. Such devices are sometimes referred to as Demand Response Enabling Devices (DRED). DREDs are typically positioned near a consumer appliance, for example the compressor of an air conditioner, and are hard-wired into the power supply and also wired into the DRM circuitry within the air conditioner compressor. The DRED then receives signals transmitted from an energy provider/retailer which the device converts into pulses and sends to the DRM within the air conditioner compressor to switch off, or step down, the power consumption according to the setting requested by the energy provider/retailer.

In one example of a DRED currently available, a signal receiver enables ripple control of appliances such as air conditioners. Skilled readers will understand that ripple control (based on audio frequency load control) involves superimposing control signals using higher frequencies on the main power line and programming non-essential residential or industrial loads (such as air conditioners, water heaters and pool pumps) that receive this superimposed control signal to recognize the signals and turn electrical devices off and on, or operate the device at a reduced power consumption level according to the control signal.

However, there are disadvantages associated with existing systems, including, but not limited to, the fact that such systems operate using a simplex signal communication arrangement. Accordingly, whilst energy retailers are able to transmit a signal to the signal receiver installed on a consumer's electrical device to control the operation of the electrical device, there is no means by which retailers are able receive confirmation from the consumer's device to confirm that the amount of energy actually consumed by the device conforms with the requested reduced power level. Accordingly, existing systems effectively rely upon an assumption that the signal was received and appropriately actioned. Effectively, currently available systems assume that a transmitted DRED signal is received and implemented. Of course, there is a motivation for consumers to tamper with their electrical device (appliance or load) to receive a rebate as a result of a belief that the device is operating at a reduced power level whereas the interference by a consumer may result in the device operating at normal power consumption levels.

Additional problems associated with existing DREDs include reduced accuracy associated with signals from the energy providers/retailers to turn off, or step down, the power consumed by an electrical appliance and the inability to record actual power usage of those devices. Current arrangements also do not provide the ability to verify that a signal sent by an energy provider/retailer has been received by the DRM circuitry associated with a particular consumer appliance. In an effort to circumvent this problem, providers of DREDs have relied upon the installation of a Global System for Mobile (GSM) communications to send text messages by Short Message Service (SMS) to verify whether a signal has been received, which is not ideal for various reasons.

Existing DREDs are also configured specifically to enable DRM functions within consumer appliances, and in some cases, also enable the transmission and receipt of text messages. Accordingly, in order to access the benefits of DRM, consumers and/or energy providers/retailers are required to purchase a device that provides a limited and specific function and install the device thereby increasing the financial commitment required of the consumer and/or the energy provider/retailer.

The present invention seeks to address at least one or more of the above problems associated with managing peak energy demands and avoiding blackouts.

A further problem occurs when DRED enabled devices lose power for a sufficient period of time causing the device to lose any recorded memory of a DRED setting at the time of power loss. At the time power is restored, the consuming device may revert to full power consumption thereby disrupting or frustrating the efforts of an Energy Manager seeking to manage the demand of a power grid to avoid loss of power to any consumer during peak periods.

### SUMMARY OF THE INVENTION

In one aspect, the present invention provides an electrical power consumption control unit that controls power consumed by one or more electrical devices connected thereto including a computer processor having a memory operably connected thereto storing computer instruction code, the unit further including a communication module operable to receive control signals from a remotely located energy manager requesting modification of power consumed by the one or more connected electrical devices, a monitoring module operable to monitor power consumed by the one or more connected electrical devices, and wherein the computer instruction code, when executed by the computer processor, causes the computer processor to control the supply of electrical power to the one or more connected electrical devices, and transmit one or more notifications to the remotely located energy manager regarding the power consumed by the one or more connected electrical devices.

In an embodiment, the monitoring module is operable to measure and/or record power consumed by one or more connected electrical devices.

In an embodiment, the measurement and/or recording of power consumed is substantially continuous.

In an embodiment, the one or more notifications include the status of the requested notification to power consumption.

In an embodiment, control signals requesting modification of power consumption include signals that cause operating load of each of one or more of the one or more connected electrical devices to be modified from X% to Y%, wherein X and Y represent integers from 0 to 100. For example, X may represent 100% and Y may represent 75% thereby causing the one or more connected electrical devices to reduce their power consumption from 100% to 75% of the full operating capacity of the device.

In another example, X may represent 100% and Y may represent 50%, thereby causing the one or more electrical devices to reduce their power consumption from 100% to 50% of the full operating capacity of the device.

In yet another example, X may represent 75% and Y may represent 50%, thereby causing the one or more electrical devices to reduce their power consumption from 75% to 50% of the full operating capacity of the device.

In an embodiment, the control signal causes disconnection of the operating load of the connected electrical device. Alternatively, the control signal may correspond to connection of the operating load of the electrical device.

In an embodiment, the one or more notifications include a status of the requested modified power consumption of the one or more connected electrical devices. The one or more notifications may also include a record or amount of power consumed by the one or more connected electrical devices, wherein the record includes the current operating status of the one or more connected electrical devices as compared with the full operating capacity of the device(s).

The control signals may be transmitted using any one or more wireless communication protocols. Examples of wireless communication protocols that may be adopted in the present invention include, but are not limited to, Bluetooth, GSM or Zigbee.

In an embodiment, the wireless communication may be selected from any one or more of satellite communication, infrared wireless communication, radio communication, microwave wireless communication or Wi-Fi communication.

In an embodiment, the power consumption control unit is operable to communicate with a plurality of power consumption control units, wherein the computer instruction code, when executed by the computer processor, causes the computer processor to transmit contents of the computer memory to the plurality of power consumption control units and receive memory contents from the plurality of power consumption control units. In this particular embodiment, communication between power consumption control units enables the units to receive important stored details in all other units within the communication vicinity of a particular electrical power consumption control unit. In this regard, one particular power consumption control unit could receive and store details from many surrounding power consumption units including details such as the adjusted power consumption level and stored details regarding the power consumed by electrical devices connected to the other electrical power consumption control unit. In this way, the electrical power consumption control units effectively form a mesh network with each unit receiving and saving important data with respect to a range of other units within communication vicinity and vice-versa and in the event of power loss or damage occurring to one of the electrical power consumption control units, important data may be retrieved from surrounding units within communication vicinity. This may be useful in instances where a replacement consumption control unit is installed and the last operating memory of that device may be retrieved from another unit located nearby and/or in instances where an energy manager seeks to recover the latest data from a power consumption control unit by interrogating another unit within communication vicinity of the unit of interest. In some circumstances, it is conceivable that a power consumption control unit may develop a fault within the communication module thereby preventing the energy manager from receiving notifications regarding actual power consumption although, data sought by the energy manager regarding a particular power consumption control unit may have been transferred to another control unit prior to the failure of the communication module and the energy manager may interrogate the other units nearby to the control unit of interest to determine whether the nearby control units have stored the data sought by the energy manager. Similarly, in the event of power loss, it is conceivable that some control units may initialize with a return of power and experience data corruption thereby preventing the control unit from resuming operation from its last operating settings. In this instance, upon detecting data corruption, a control unit may request a copy of the latest control settings for that unit from nearby control units within communication vicinity.

In an embodiment, the energy manager is an energy retailer and may be the same entity that provides rebates to customers in return for reducing the power consumption of one or more of their connected electrical devices.

In an embodiment, the energy manager may be the entity that generates power, for example, a power station.

In another embodiment, the energy manager may be an entity that merely monitors, measures and/or records the consumption of power and is independent from the entities responsible for the generation of power, the sale of power or the provision of rebates to consumers.

In another aspect, the present invention provides a system for controlling power consumed by one or more electrical devices, the system including a remotely located energy manager requesting modification of power consumed by the one or more electrical devices, and one or more electrical power consumption control units connected to the one or more electrical devices to which power is supplied from an electrical power grid, wherein each one of the one or more electrical power consumption control units includes a computer processor having a memory operably connected thereto storing computer instruction code, the one or more units further including a communication module operable to receive control signals from the remotely located energy manager, a monitoring module operable to monitor power consumed by the one or more electrical devices, wherein the computer instruction code, when executed by the computer processor, causes the computer processor to control the supply of electrical power to the one or more electrical devices in accordance with control signals transmitted from the energy manager, and transmit one or more notifications to the remotely located energy manager regarding the power consumed by the one or more electrical devices.

The one or more notifications transmitted to the energy manager may include an acknowledgment that the communications module has received one or more control signals from the energy manager.

In the event the energy manager does not receive an acknowledgement that the request for modification of power consumed by the one or more electrical devices has been received by the communications module, the energy manager may poll the communication module until an acknowledgement is received. In an embodiment, the system and method also includes the computer processor transmitting a notification to the energy manager and/or consumer in the event an acknowledgement of a request for modification of power consumed by the one or more electrical devices is not received by the communications module within a pre-defined number of polling attempts or after a specified period of time.

In an embodiment, an energy manager may also receive a notification from the computer processor of an electrical power consumption control unit that the one or more electrical devices are operating at a higher power load as compared with the load requested by the energy manager.

In addition to transmitting one or more notifications to an energy manager, the one or more notifications may be transmitted to the cloud, one or more other electrical power consumption control units or one or more other consumers.

In another aspect, the present invention provides a non-transitory computer readable medium including computer instruction code which, when executed, causes an electrical power consumption control unit to perform various tasks, the control unit having a computer processor and a memory operably connected thereto for storage of computer instruction code, a communication module operable to receive control signals from a remotely located energy manager and a monitoring module operable to monitor power consumed by one or more electrical devices connected to the electrical power consumption control unit, the tasks including: monitoring issued requests from an energy manager to adjust power consumption and upon receipt of a request, controlling the electrical power provided by the electrical power consumption control unit, monitoring the actual electrical power consumed by electrical devices connected to the electrical power consumption control unit and transmitting one or more notifications by the communication module to the energy manager regarding the actual power consumed by the one or more connected electrical devices.

In another aspect, the present invention provides a method for controlling power consumed by one or more electrical devices located at one or more sites having one or more electrical power consumption control units including, a computer processor having a memory operably connected thereto storing computer instruction code, the one or more electrical power consumption control units further including a communication module operable to receive control signals from a remotely located energy manager who issues requests regarding modification of power consumed by one or more electrical devices connected to the one or more electrical power consumption control units, a monitoring module operable to monitor power consumed by one or more connected electrical devices, the method including issuance of requests to adjust power consumption from the energy manager, said requests received by one or more electrical power consumption units wherein the computer instruction code, when executed by the computer processor, causes the computer processor to control the supply of electrical power to the one or more connected electrical devices in accordance with the energy manager request and monitors the actual power consumed with the monitoring module, and transmits one or more notifications to the remotely located energy manager regarding the actual power consumed by the one or more connected electrical devices.

### BRIEF DESCRIPTION OF THE DRAWINGS

Embodiments of the invention will now be described in further detail with reference to the accompanying figures in which:

FIG. 1 depicts a diagrammatic representation of components of a system according to an embodiment of the present invention;

FIG. 1a is an enlarged view of the control units (4) and compressor (40) depicted I the embodiment in FIG. 1;

FIG. 2 depicts an example of an installation of an electrical device that is operable to be managed according to an embodiment of the present invention;

FIG. 3 depicts various embodiments of an apparatus that forms a component of a system according to the present invention;

FIG. 4 depicts a particular embodiment in which a “mesh network” of control units is established to reliably control the electrical power consumption of a dwelling;

FIG. 5 depicts an embodiment relating to a commercial installation including 12 air conditioning compressor units in respective of which only a small number of compressor units are connected to a control unit including facilities to communicate with a remotely located energy manager with all other control units effectively acting as “slave” units solely including local communication facilities;

FIG. 6 depicts an embodiment in which an organisation seeks to control energy consumption of energy consuming facilities remotely located from one another and remotely located from the user operating a user interface to control the energy consumption from the remotely located facilities operated by the organisation;

FIG. 7a depicts an example user interface on a display that reports to the user various information including the number of electrical devices, the status of those devices and the energy savings according to an embodiment of the present invention;

FIG. 7b depicts an alternative user interface detailing the Geo-location of devices according to an embodiment of the present invention; and

FIG. 7c depicts a further user interface providing a visual display reporting real-time assets and detailing their status, location, firmware mode and monitoring demand/response capabilities according to an embodiment of the present invention.

### DETAILED DESCRIPTION OF EMBODIMENT(S) OF THE INVENTION

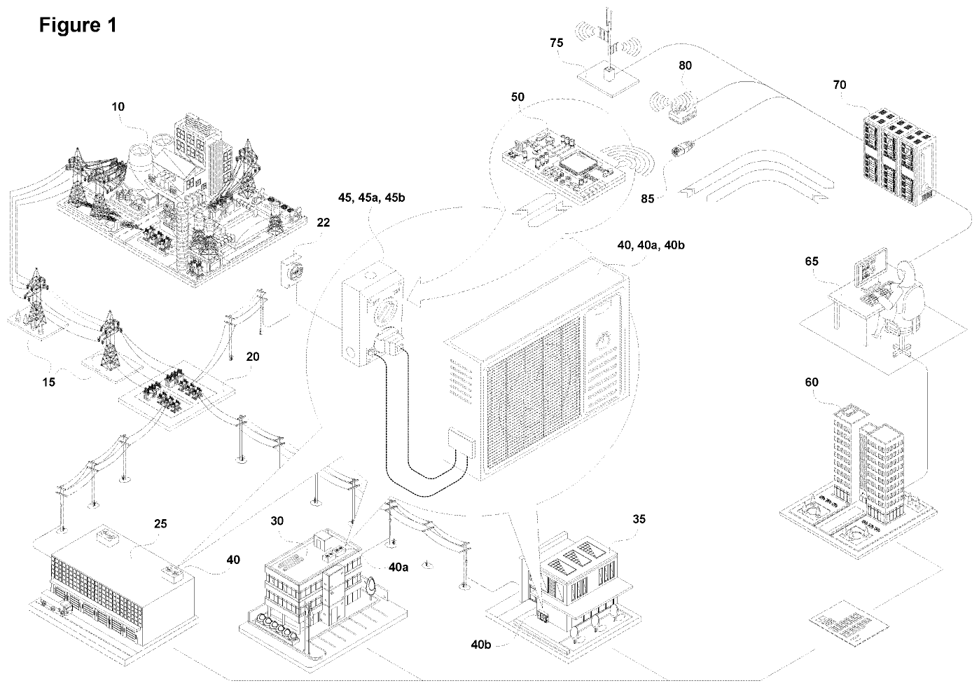

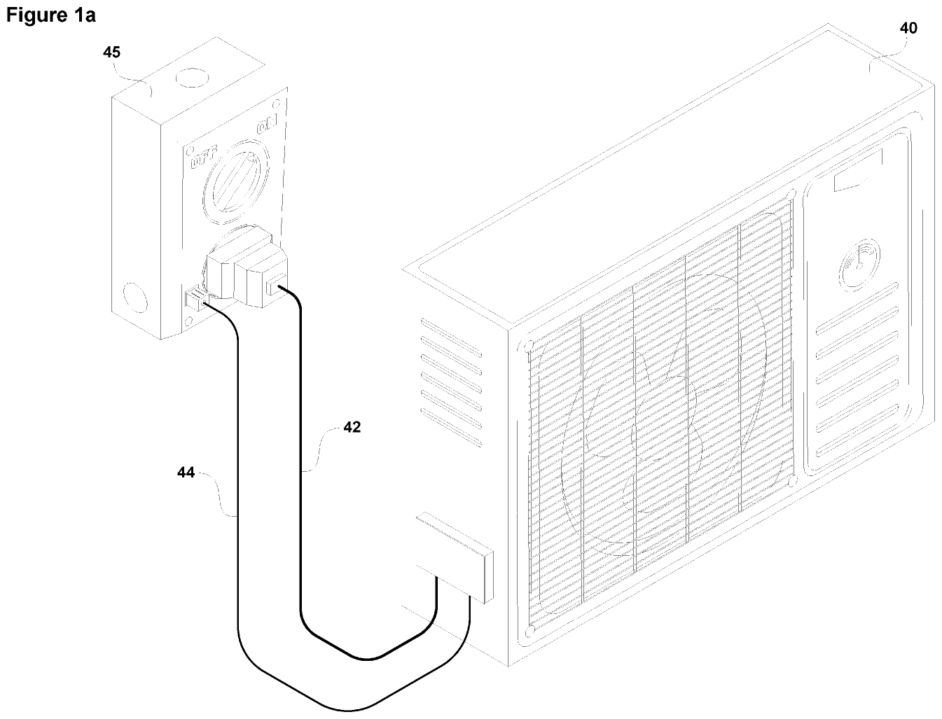

With reference to FIG. 1, a diagrammatic representation of basic components according to an embodiment of a system of the present invention is provided in which electrical devices (40, 40a, 40b) are operably connected to respective electrical power consumption control units (45, 45a, 45b) such that the control units (45, 45a, 45b) control the power consumed by the respective connected electrical devices (40, 40a, 40b) during operation. In the particular instance of FIG. 1, the electrical device is the compressor of an air conditioning unit and further, electrical device (40) is located in a commercial premises, electrical device (40a) is located in a multi-residential dwelling and electrical device (40b) is located in a single residence dwelling. As will be appreciated, the compressor units of the respective electrical devices (40, 40a, 40b) will have different operating capabilities and capacities in view of the configuration of the air conditioning installation for each of the types of installations, namely, commercial, multi-residential dwelling and single domestic dwelling. However, in each instance, the electrical devices (40, 40a, 40b) are provided electrical power by a respective electrical power consumption control units (45, 45a, 45b) which control the electrical power consumed by any connected electrical device during operation.

As usual, the electrical devices depicted in FIG. 1 (40, 40a, 40b) are indicative of typical electrical devices operating in an electrical power generation and consumption network wherein electrical power is generated by an electrical power station (10) with the electrical power transmitted through a transmission network (15) to a substation (20) that transforms the high voltage over which power is transmitted by the transmission network (15) to a lower voltage more appropriate for electrical devices and this is effected by substation (20). Electrical power is generally provided to commercial and/or domestic dwellings through a main isolating switch (22) and in the example of FIG. 1, electrical power consumption control units (45,45a, 45b) would be typically connected to a main switch (22) in a commercial or domestic dwelling.

Each of the electrical power consumption control units (45, 45a, 45b) depicted in the embodiment of FIG. 1 include a printed circuit board (50) including various electric hardware components operably connected thereto that provide various operational capabilities to the control unit (45). In particular, the printed circuit board (50) includes a computer processor and associated electronic components that provide the control unit (45) with operational capabilities such as a communication module operable to receive control signals from a remotely located energy manager (65), a monitoring module that monitors power consumed by connected electrical devices and electronic components that are operable to control the supply of electrical power to any connected device (e.g. 40, 40a, 40b). The communication module that is operable to receive control signals from a remotely located energy manager (65) is also operable to transmit one or more notifications to the remotely located energy manager (65) to provide data regarding the actual power consumption of electrical devices (40, 40a, 40b) connected to their respective electrical power consumption control unit (45, 45a, 45b).

In the embodiment depicted in FIG. 1, one or more notifications are communicated to a remotely located energy manager (65) regarding power consumed by the electrical devices (40, 40a, 40b) which may be communicated by various means including communication effected by the cell phone network (75), a Wi-Fi device (80) or any other local area alternative communication means such as Blue-tooth or Zigbee (85) for subsequent further transmission. Communication effected by any means within the control device (45) is communicated to the remotely located energy manager (65) with all data recorded in a data storage facility (70). Data stored in the storage facility (70) may be interrogated by the energy manager (65), or the energy management utility (60), to either assist immediate decisions regarding energy management by the energy manager (65) or to determine the provision of rebates by the energy management utility (60) during a historical review of the data stored in the data facility (70).

The control unit (45) is preferably enabled to communicate with the remotely located energy manager (65) by means of a communication facility that provides a full duplex communication link. In alternative embodiments, the communication link between the control unit (45) and the remotely located energy manager (65) may be effected by a half-duplex communication link but in any event, the communication link between the control unit (45) and the remotely located energy manager (65) must be a communication link operable such that the remotely located energy manager (65) is able to receive notifications and data from control units (45, 45a, 45b) regarding actual electrical power consumption by connected electrical devices (40, 40a, 40b) and transmit requests to control units to adjust the power consumption of connected electrical devices.

In the embodiment depicted in FIG. 1, the remotely located energy manager (65) is operably connected by the communication link to the control units (45, 45a, 45b) such that the remotely located energy manager (65), by combination of wireless and/or wired communications, may issue requests to the control units (45, 45a, 45b) to adjust the electrical power provided to connected electrical devices (40, 40a, 40b). In a preferred embodiment, the control units (45, 45a, 45b) are operable to effect modification of power consumed by connected electrical devices (40, 40a, 40b) in response to receiving requests from a remotely located energy manager (65) in accordance with the Demand Response Management (DRM) protocol. In this regard, in those countries that have adopted the DRM protocol and have devices installed in residential and commercial premises operable to receive and implement DRM commands, the preferred embodiment is operable to effect all of the presently available eight DRM commands. In this regard, the DRM commands include a request to disconnect the electrical device, to activate the electrical device, and also to regulate the consumption of electrical power by an electrical device that is a Demand Response Enabling Device (DRED) which includes reduced energy consumption modes, such as, for example 50% and 75% of full operational consumption.

With reference to FIG. 1a, an enlarged view of the control unit (45) and the connected compressor unit (40) depicted in FIG. 1 is provided. This enlarged view provides greater detail regarding the connection between the control unit (45) and the compressor unit (40) and in particular, details the power connection (42) between the control unit (45) and the compressor unit (40) over which electrical power is supplied to the compressor unit (40).

FIG. 1a also details the electrical connection (44) between the control unit (45) and the compressor unit (40) and in this regard, the electrical connection (44) transmits DRM requests from the control unit (45) to the compressor unit (40). The electrical connection (44) over which DRM requests are transmitted from the control unit (45) to the compressor (40) is only required to provide communication in a single direction, namely, from the control unit (45) to the compressor (40). Once the compressor (40) receives a DRM request from the control unit (45), the compressor (40) receives the DRM request and effects the DRM request which affects the electrical power consumed by the compressor unit (40). Since the control unit (45) measures the electrical power provided to connected devices in addition to providing power to those devices, the measurement of the electrical power provided to the compressor unit (40) provides confirmation regarding the compressor unit (40) enacting the DRM request that it receives over the electrical connection (44) from the control unit (45). Communication regarding the electrical power provided by the control unit (45) to the compressor unit (40) provides a remotely located energy manager with the assurance that the DRM request transmitted to the compressor unit (40) has been received and enacted such that the compressor unit (40) is consuming electrical power according the DRM request.

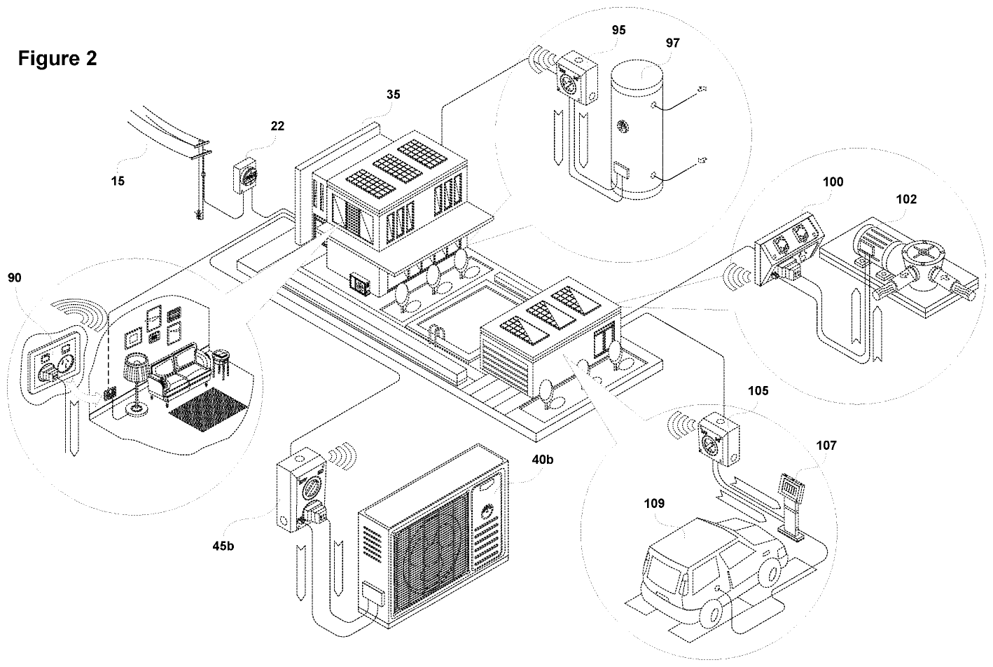

With reference to FIG. 2, further detail regarding the single domestic dwelling (35) of FIG. 1 is depicted in which a main switch (22) provides electrical power to the single domestic dwelling (35) supplied by the transmission network (15).

In the embodiment of FIG. 2, in addition to an air conditioning compressor (40b), the single domestic dwelling (35) also includes various other electrical energy consuming devices such as an electrical hot water heater (97), a swimming pool pump (102), an electric car charging station (107) and a general purpose outlet (GPO) (90). Of course, the GPO (90) enables connection of a range of electrical devices and in the instance of FIG. 2, the GPO (90) is depicted providing electrical power to an electrical lighting device.

Each of the electrical devices depicted in FIG. 2 are provided with electrical power by an electrical power consumption control unit. In this regard, the air conditioning compressor (40b) is connected to, and provided electrical power by control unit (45b), electric water heater (97) is provided electrical power by control unit (95), the swimming pool pump (102) is provided electrical power by control unit (100) and the electric car (109) is recharged by the electric car charging station (107) provided with electrical power by control unit (105). In the embodiment depicted in FIG. 2, the GPO (90) is a unitary component comprising both a General Purpose Outlet that incorporates the components and associated hardware and software to effect the functions of an electrical power consumption control unit according to the present invention.

In the embodiment of FIG. 2, each of the control units (45b, 95, 100, 105 and 90) have a communication module that enables the control unit to communicate by Wi-Fi with either a router installed within the single domestic dwelling (35) or a Wi-Fi device within operable communication range external to the dwelling (35). In other embodiments, the communication module may effect communication via GSM, Blue-tooth and/or any alternative means of communication that is commercially available. In this regard, the ability of each control device to communicate with an energy manager enables a remotely located energy manager to issue requests to each individual control unit to request an adjustment to the electrical power consumed by the electrical devices connected to the respective control devices. Similarly, as the control devices provide electrical power to connected electrical devices and monitor the actual power consumed, the control devices transmit information to the energy manager such that the energy manager receives information pertaining to the actual power consumed by connected electrical devices connected to the control unit at any time.

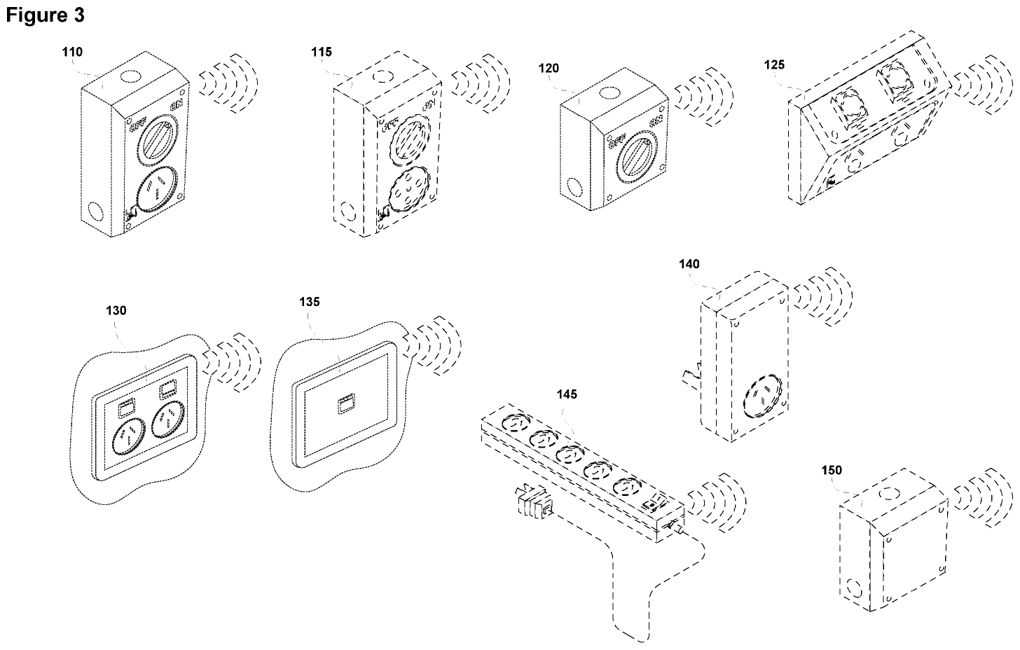

With reference to FIG. 3, various embodiments of control devices are depicted. In this regard, control device (110) comprises a weatherproof General Purpose Outlet (GPO) with an isolating switch for the provision of single phase electrical power to a connected device. In the instance of control device (115), a similar embodiment comprising a weatherproof enclosure is included with a GPO for the provision of 3 Phase electrical power to connected devices. Control device (120), comprises a weatherproof enclosure with an isolating switch but does not provide a General Purpose Socket and, in this regard, control device (120) is typically used in instances where the electrical device is connected by fixed wiring such that it cannot be easily or inadvertently be disconnected from an electrical power supply.

Further depicted in FIG. 3 is an embodiment of a control device (125) comprising a dual gang General Purpose Outlet including a weatherproof enclosure and weatherproof switches. This particular embodiment is typically installed around commercial and/or domestic dwellings outside of the dwelling and hence exposed to varying weather conditions.

FIG. 3 also depicts a range of embodiments of electrical power consumption control units that would typically be used indoors including control unit (130) comprising a dual gang internal GPO for the provision of single phase electrical power to a connected electrical device. Further, control unit (135) comprises a single switch arrangement for the supply of electrical power to a device that is connected by fixed wiring such that the device cannot be inadvertently disconnected and is appropriate for electrical devices that occupy a fixed location and do not require to be re-located. A typical example of a fixed electrical device that, once installed, does not require re-location includes lighting devices.

Also depicted in FIG. 3 is an embodiment of a control unit (145) comprising an electrical extension board. In this instance, control unit (145) comprises a 5 gang GPO electrical extension board with a single switch operable to connect electrical power to each of the single gang GPO outlets. Further depicted in FIG. 3, is an embodiment of a control unit (140) that is configured for connection between a standard non-controlled domestic GPO and an electrical device connected to a standard GPO. In this regard, the control unit (140) may be connected between a standard GPO and electrical device (such as an electric heater) thus enabling the electrical power provided to the electrical device (e.g. electric heater) to be controlled. Yet a further configuration of a control unit is depicted in FIG. 3 comprising a control unit (150) that does not provide any external switching mechanism and this particular embodiment is suitable for a fixed electrical device that is expected to be connected continuously to electrical power. However, the installation of a control unit (150) enables fixed electrical devices with fixed connection to electrical power to be controlled by the control unit (150).

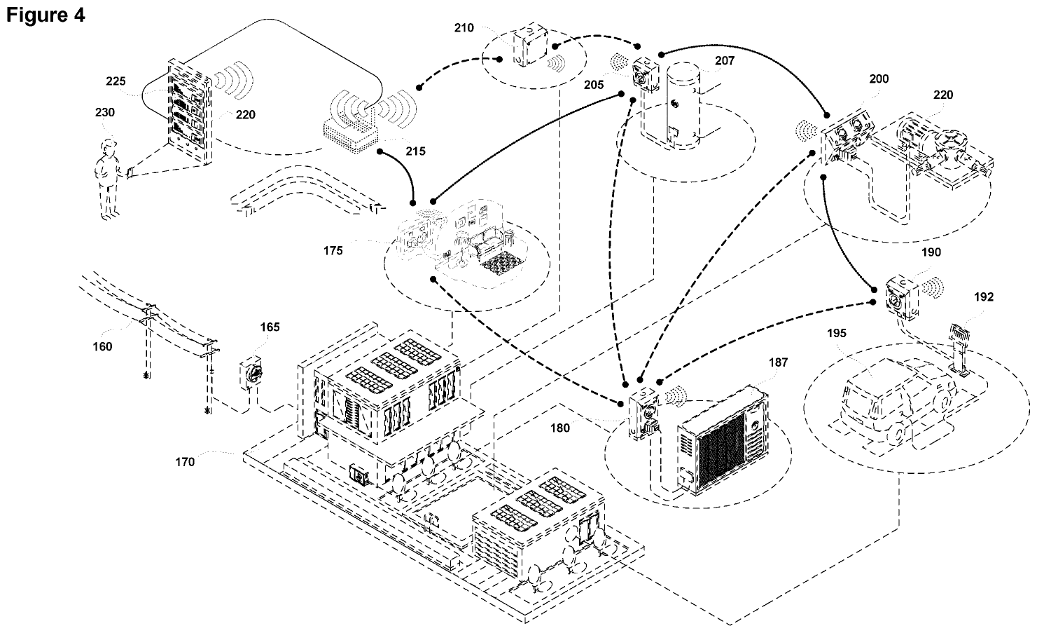

With reference to FIG. 4, a typical single dwelling installation is depicted comprising a single domestic dwelling (170) provided with electrical power through a main switch (165) that is connected an electrical transmission network (160). In the example of FIG. 4, the single domestic dwelling (170) includes a range of electrical devices connected to electrical power consumption control units, namely, an air conditioning system (187) provided with electrical power through control unit (180), an electric hot water heater (207) provided with electrical power by control unit (205), a swimming pool pumping apparatus (220) provided with electrical power by control unit (200), an electric vehicle (195) charged by an electric car charging station (192) provided with power by control unit (190) and a General Purpose Outlet (GPO) (175) that includes a control unit and is available for the connection of any non-fixed electrical device such as a lighting apparatus.

Further, in the embodiment of FIG. 4, each of the control units (180, 205, 200, 190 and 175) are in operable communication with a Wi-Fi device (215) in addition to being in operable communication with each other. In this regard, control unit (180) is in operable communication with the other control units (175, 205, 200 and 190). Similarly, all of the remaining control units are in operable communication with each other in addition to being in operable communication with the Wi-Fi device (215). Effectively, the control units form a “mesh network” between each other including the Wi-Fi communication device (215). In the particular embodiment of FIG. 4, a control unit (210) comprising a device for fixed electrical devices that require continuous connection to electrical power is also included in the mesh network and as a result of the inclusion of the control unit (210), a fixed electrical device consuming electrical power continuously is able to have the electrical power consumed by any such fixed electrical load controlled.

As for all the remaining control units depicted in FIG. 4, control unit (210) is in operable communication with all remaining control units within the dwelling in addition to the Wi-Fi communication device (215). In the embodiment of FIG. 4, all of the control units are in operable communication with a remotely located energy manager. Accordingly, any request from a remotely located energy manager received by control unit (215) within the mesh network of control units may be forwarded for receipt and activation by another control unit to which the power consumption request was addressed.

In other words, the establishment of a mesh network between control units located in a single dwelling substantially improves the reliability with which power consumption requests issued by an energy manager are received and enacted by control units within the mesh network. For example, where one or more control units within a mesh network are temporarily shielded from communication with an energy manager, in the event that any other control unit within the mesh network are not shielded and operable to receive a power consumption request for another control unit member of the mesh network, the receiving control units may forward the received power consumption adjustment request to the intended recipient of the mesh network. This arrangement substantially increases the reliability with which power consumption requests may be issued and received and enacted by control units with connected electrical devices.

Ultimately, despite the best efforts of an energy manager to avoid situations wherein energy demand exceeds generation capacity, it is possible that power outages will occur wherein a premises is deprived of electrical power for a period of time. In one embodiment, the control units include a memory device that stores the current status of the control unit and the DRM setting of any electrical devices connected thereto. Further, in embodiments where a mesh network of control units is formed, the control units store the current status of all control units within the premises. In accordance with this particular embodiment, when the premises is reconnected with electrical power, all of the electrical devices installed within the premises that are connected to a control unit may have their status restored as a result of the data stored in the memory of the connected control unit, or another control unit within the mesh network, thereby enabling all electrical devices connected throughout the premises to resume operation in accordance with the DRM energy setting that applied at the time the premises was disconnected from electrical power. In addition, the memory device in each of the control units within the mesh network may also store historical data regarding the power consumption of electrical devices connected to each of the control units within the mesh network. Accordingly, despite a loss of power to a premises or dwelling, when the control units resident within that premises or dwelling are operable to form a mesh network, the control units may collaboratively restore the existing power consumption settings at the time of lost power and also restore historical details regarding measured power consumed by electrical devices connected to respective control units within the mesh network. In this particular embodiment, in instances where individual control units may have a stored energy consumption schedule to control electrical power consumption in the future, those details may also be stored in each of the respective control units included within the mesh network and similarly, may be restored to each of the control units within the mesh network upon reconnection of electrical power and/or in the event that any particular control unit suffers data corruption with respect to their memory contents.

In another embodiment, control units include a number of available communication means to effect communications with a remotely located energy manager and in the event that any one communication means becomes unreliable or ineffective during operation of the control unit, the control unit engages an alternative communication means in an attempt to re-establish communications with the remotely located energy manager. In one particular embodiment, when a control units seeks to engage an alternative communication means with which to attempt to re-establish communication with a remotely located energy manager, the control unit attempts to re-engage communications by use of communication means that is the next most least expensive communication option and steps through the available communication facilities available to the control unit in order of least expensive to most expensive in an attempt to re-establish communication with the remotely located energy manager. In this regard, a control unit may include a range of communication facilities including the facility to receive and transmit communications in accordance with the Lora Protocol (a communications protocol for Wide Area Networks to communicate with the Internet of Things (IoT), Wi-Fi, Bluetooth and/or GSM communication means and may step through one or more of the various communication facilities available to the control unit to re-establish communications with a remotely located energy manager.

Of course, maintaining communication with a remotely located energy manager is important for the purpose of continuing to receive requests regarding adjustment of the power consumed by connected electrical devices, but also to ensure that the remotely located energy manager continues to receive updated information regarding the actual power consumed by electrical devices connected to control units over time.

As also depicted in FIG. 4, a user (230) may effect control of the electrical energy consumption of a premises by use of a mobile communications device (220) thereby effecting personal control of the electrical power consumption by electrical devices within the dwelling irrespective of requests received by a remotely located energy manager. In this instance, whilst rebates may be applicable during periods of peak load which are managed by a remotely located energy manager, during other periods a user (230) may prefer to control the electrical power consumption of a dwelling (170). In the embodiment of FIG. 4, the user (230) uses the communications device (220) that is in operable communication with the Wi-Fi router (215) to effect control of individual control units (180, 205, 200, 190 and 175). The communications device (220) may communicate with control units either directly or through the Wi-Fi router (215).

Further, the communications device (220) may also receive notifications regarding the actual power consumption of control units installed within the dwelling and the user may review power consumption information on the display (225) of the communications device (220) which may assist the user (230) to make decisions regarding the control of electrical power consumption by electrical devices installed within the dwelling.

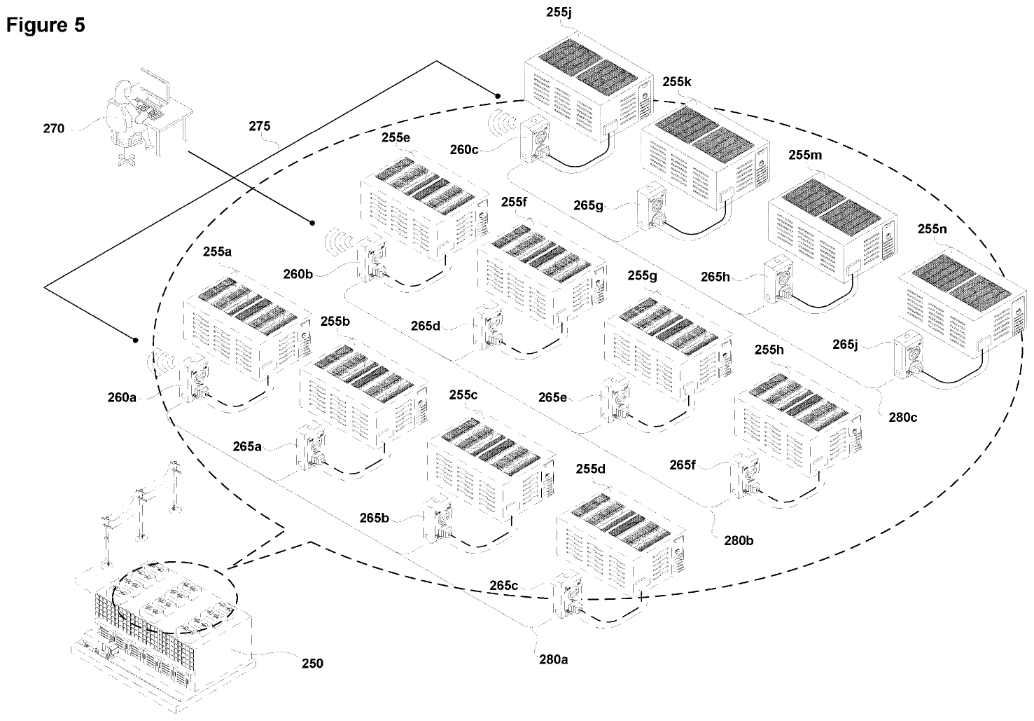

With reference to FIG. 5, an embodiment is depicted wherein the installation of control units comprises two different types of control units, namely, a master control unit which includes communication facilities to communicate with a remotely located manager, and slave control units which solely comprise communication facilities operable to locally communicate with other control units within a single premises or dwelling.

In this regard, a commercial premises (250) is depicted in which the roof-top of the commercial premises (250) includes 12 air conditioning compressor units (255a-255n) all of which consume electrical power during operation to cool the commercial premises (250).

In the embodiment detailed in FIG. 5, each compressor unit (255a-255n) is provided electrical power by a respective control unit. In the instance of compressor units (255a, 255e and 255j), the electrical power provided to these air conditioning compressor units is provided by master control units (260a, 260b and 260c). Each of the master control units (260a, 260b and 260c) includes a communications module operable to communicate with a remotely located energy manager (270). Communication between the remotely located energy manager (270) and the master control units (260a, 260b, 260c) occurs across a communication link (275).

Whilst the master control units (260a, 260b, 260c) may receive instructions and requests from the remotely located energy manager (270) that requests adjustment to the electrical power provided by one or more of the master control units (260a, 260b, 260c), the master control units (260a, 260b, 260c) may also receive instructions and/or requests from the remotely located energy manager (270) that is intended for one of the slave control units (265a-265j). Communication between slave control units is restricted to the wired communication lines (280a, 280b and 280c) which enables groups of slave control units to communicate with each other. In this regard, wired communication line (280a) enables communication between slave control units (265a, 265b and 265c). Similarly, wired communication line (280b) enables communication between slave control units (265d, 265e and 265f). Further, wired communication line (280c) enables communication between slave control units (265g, 265h and 265j). Communication between slave control units may be effected by any local communications arrangement including the fixed wiring arrangement depicted (280a, 280b or 280c) or by Bluetooth, local Wi-Fi or any other commercially available communication arrangement.

The slave control units (265a-265j) depicted in FIG. 5 include a communication module that is solely restricted to the fixed communication across fixed wiring and hence communication between slave control units is solely restricted to communication lines (280a, 280b and 280c). As also depicted in FIG. 5, each communication line (280a, 280b and 280c) is also connected to a master control unit. Accordingly, in the instance of wired communication line (280a), the master control unit (260a) connected to communication line (280a) may communicate with a remotely located energy manager (270) across the communication link (275) and subsequently communicate with any one or more of slave control units (265a, 265b or 265c). Similarly, any one of slave control units (265a, 265b or 265c) may communicate across fixed communication line (280a) with the connected master control unit (260a) and may transmit data relating to power consumption of a compressor unit (255b, 255c or 255d) connected to one of the slave control units (265a, 265b or 265c) and transmit data pertaining that power consumption to the connected master control unit (260a) for subsequent communication with the remotely located energy manager (270).

As also depicted in FIG. 5, wired communication line (280b) may affect similar functionality in respect of the slave control units (265d, 265e or 265f) with the master control unit (260b) connected by communication line (280b). Similarly, slave control units (265g, 265h and/or 265j) may also communicate across a wide communication line (280c) and communicate with the connected master control unit (260c) to effect similar functionality. The primary benefit of the arrangement depicted in FIG. 5 is the ability to effect desired functionality across all 12 connected compressor units with an installation comprising 12 control units with only 3 control units comprising master control units (260a, 260b and 260c) which include the communication facilities enabling the master control units (260a, 260b and 260c) to communicate with a remotely located energy manager (270). However, whilst achieving the desired functionality, the slave control units (265a-265j) are connected to the majority of compressor units (255b, 255c, 255d, 255f, 255g, 255h, 255k, 255m and 255n) and achieve the desired functionality with a substantially reduced cost of the control unit since the slave control units avoid the requirement to include long range communication facilities and are restricted to local communication between control units connected to the same wired communication line. Alternative local communication configurations for slave control units include Powerline, Bluetooth or local Wi-Fi arrangements.

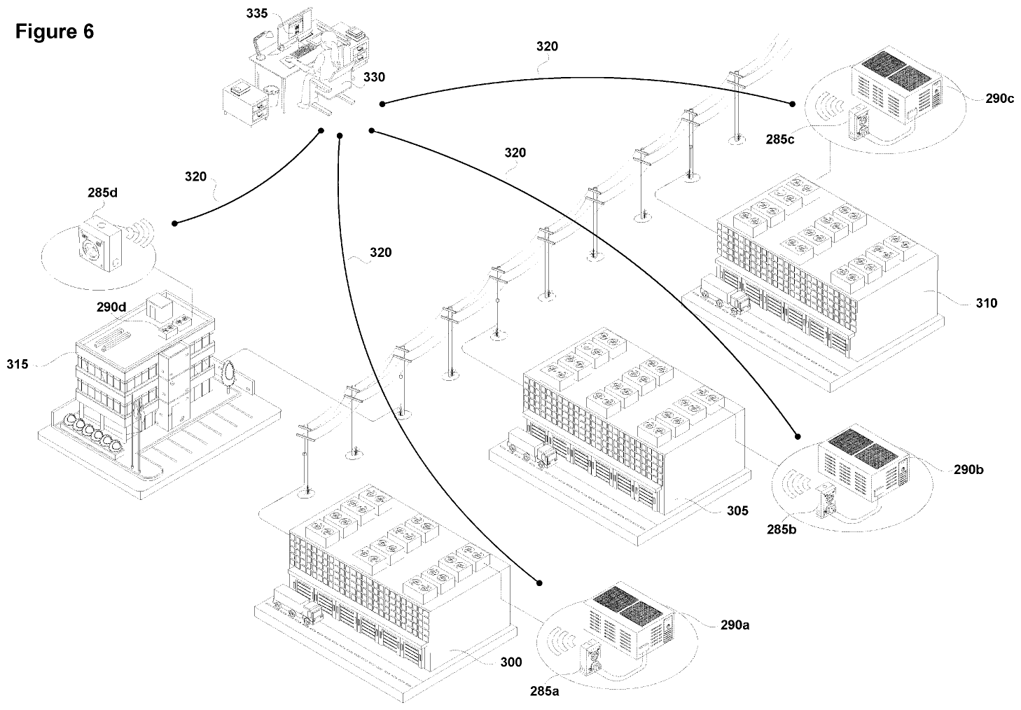

With reference to FIG. 6, an embodiment depicting a single organisation comprising four separate facilities located in separate geographic locations is depicted. In this regard, a user (330) representing an employee (officer) of the organisation seeking to control the energy consumption costs of the organization operates a user interface (335) to manage the power consumption of the separately located facilities (300, 305, 310 and 315).

Each of the facilities (300, 305, 310 and 315) include a range of electrical energy consuming devices which, in the embodiment depicted in FIG. 6, comprise air conditioning compressor units located on the roof top of each facility. Each compressor unit on the roof top of the separate facilities (300, 305, 310 and 315) are provided electrical power through a control unit and an enlarged view of a single control unit and compressor unit for each facility is identified in FIG. 6.

In this regard, facility (300) includes 12 compressor units on the roof-top with each compressor unit including a control unit (285a) providing electrical power to a compressor unit (290a). Similarly, facility (305) includes 12 compressor units on the roof-top of that facility with each compressor unit (290b) provided with electrical power through a control unit (285b). Again, facility (310) also includes 12 compressor units on the roof-top thereof with each compressor unit (290c) provided with electrical power through control unit (285c). The organisational facilities depicted in FIG. 6 also include an administration facility (315) which only includes 2 compressor units on the roof-top thereof (290d) which in this instance, is provided power through control unit (285d). The user (330) operating control of the power consuming devices of the various facilities (300, 305, 310 and 315) communicates with those facilities by a communication link (320). In the embodiment of FIG. 6, the user (330) operates the user interface of a computing system (335) to monitor the electrical energy consumption reported via communication link (320) at each of the various facilities (300, 305, 310 and 315) and issues requests across communication link (320) for one or more of the compressor units represented by (290a, 290b, 290c and 290d) to adjust the electrical power consumed by those compressor units. In addition to receiving requests from the user (330) with respect to adjustments to the consumption of electrical power by the compressor units, the connected control units (285a, 285b, 285c and 285d) record the actual electrical energy consumed by their connected electrical devices and transmits data relating to the actual electrical energy consumption to the user (330) across the communication links (320).

In the particular arrangement depicted in FIG. 6, an organisation seeking to reduce the cost of electrical energy consumed at various separately geographically located facilities may use the configuration depicted to control the electrical energy consumed by connected electrical devices at each facility thereby reducing total energy consumption costs for the organisation. In the event the organisation also seeks to avail themselves of rebates according to DRM commands issued by an energy manager, it is envisaged that the user (330) will monitor any DRM requests issued by a remote energy manager to ensure that any commands or requests issued by the user (330) do not conflict with requests issued by a remote energy manager thereby avoiding any compromise with respect to any available rebates provided by an energy supplier.

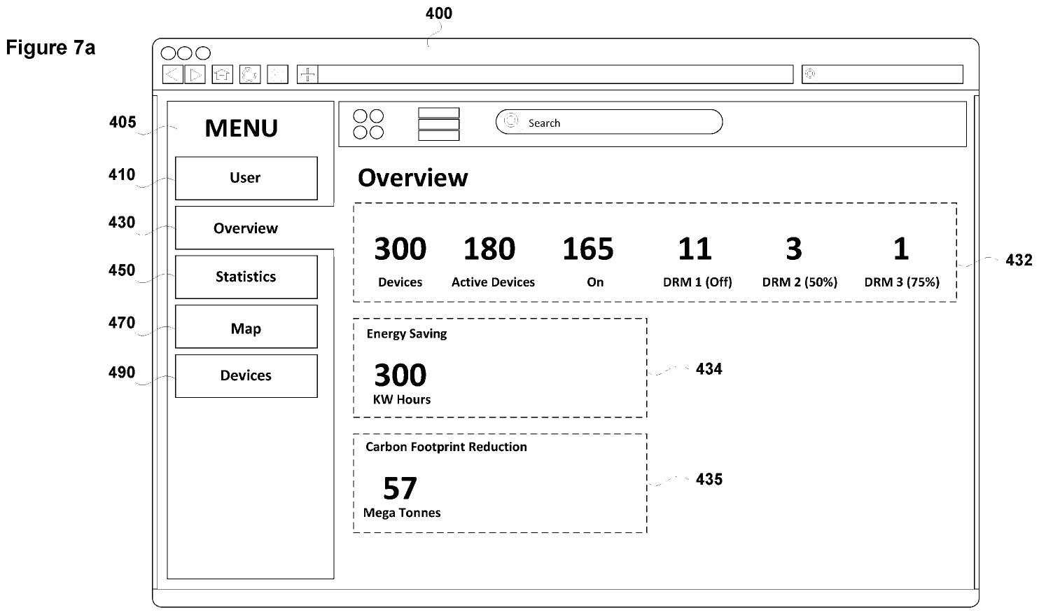

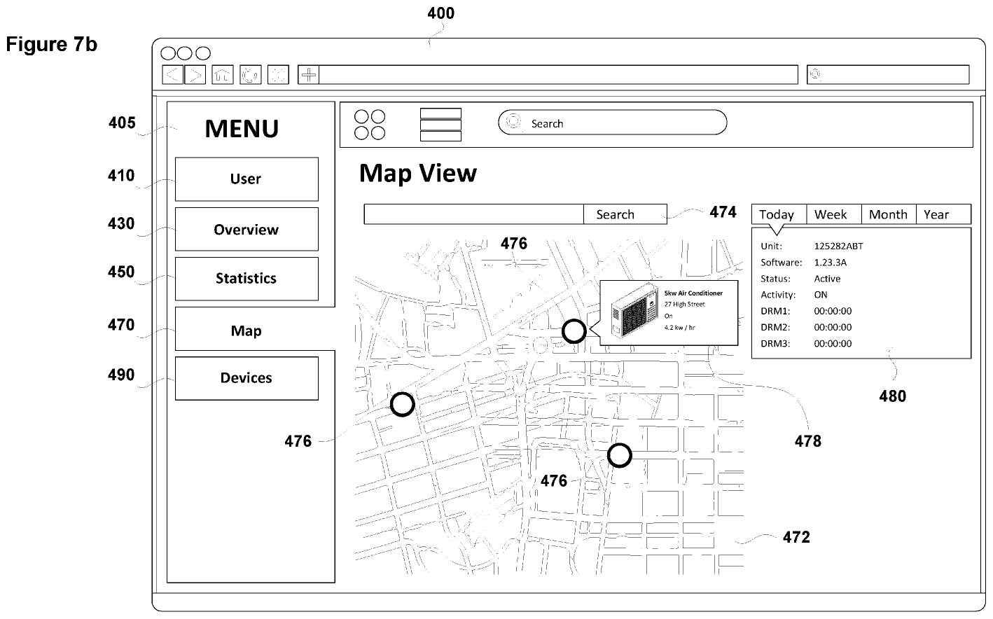

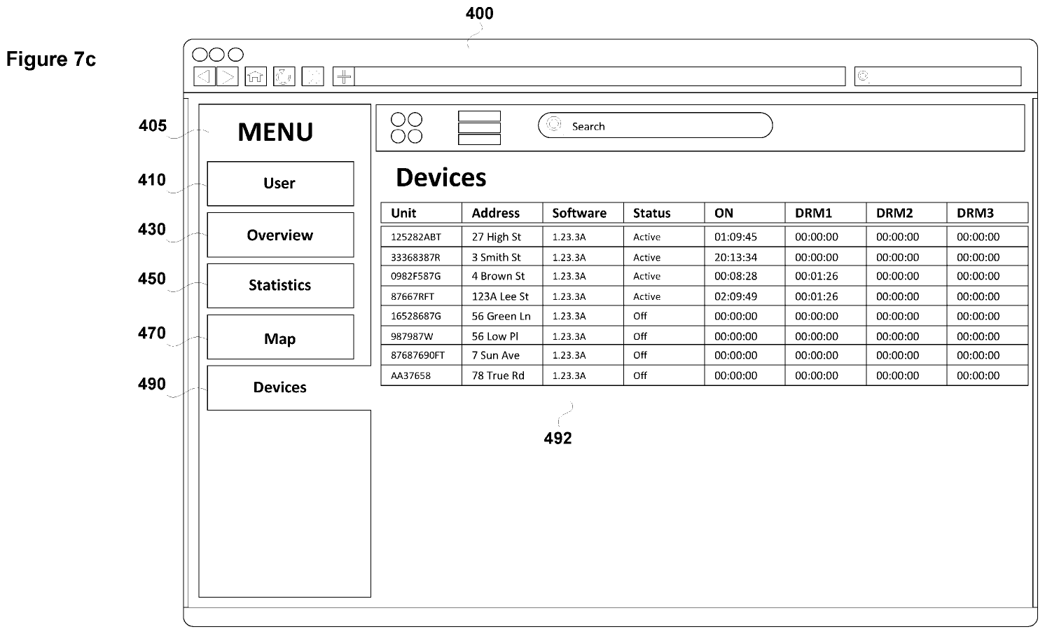

FIGS. 7a, 7b and 7c detail an embodiment of a user interface operated by an energy manager or a user seeking to control the energy consumption of premises connected to a power grid. With reference to FIG. 7a, a computer display is depicted in which details regarding the number of devices that may be controlled is displayed along with the number of active devices that are currently under the control of a control unit to modify the electrical energy consumption of devices connected thereto. The display image includes a window (400) including a menu (405) that includes a range of alternative views including views that are identified as User (410), Overview (430), Statistics (450), Map (470) and Devices (490).

The image detailed in FIG. 7a corresponds with the Overview (430) menu option and in a portion of the image (432), numerical indications are provided regarding the numbers of devices, the number of active devices, the number of devices that are “On”, the number of devices for which the DRM setting “off” has been activated, the number of devices for which the DRM setting of “50%” has been activated and the number of devices for which the DRM setting of “75%” has been activated and in respect of which confirmation has been received from individual control units that have measured the actual power consumed by connected electrical devices thus confirming that the DRM setting has been received and enacted by respective control units.

In a portion of the display (434), a numerical indication of the total energy saving is provided and in another portion of the image (435), a numerical indication of the carbon footprint reduction is provided.

With reference to FIG. 7b, the display image (400) is detailed with an alternative menu selection having been activated, namely, the Map (470) sub-menu option. Accordingly, a different detailed view is provided to a user viewing the display in which the geo-location of installed control units is displayed super-imposed upon a geographical map. In the particular instance of FIG. 7b, a geographical region is displayed (472) in which 3 control units have been installed (476) and as a result of the user “hovering” a pointing device over one of the graphical images identifying the geo-location of installed controlled units, additional detail is displayed (478) providing the viewer with greater detail regarding the installed control unit and the electrical device connected to the particular control unit. For example, in FIG. 7b, the additional detail regarding the control unit is displayed in a sub-window (478) detailing that the control unit is connected to a 5 kW air conditioning unit located at 27 High Street. The status of the air conditioning unit is “On” and the unit is reported as consuming 4.2 kW/hour.

The interface depicted in FIG. 7b also includes the ability to enter a street name or suburb in the search field (474) and conduct a search of the underlying geographical database to display the street name or suburb that the user seeks to display and provides a visual indication regarding any control units installed either on the street or within the suburb that is the subject of the search. As also depicted in FIG. 7b, in the portion of the display (480), additional detail is provided regarding the control unit that is the subject of the search and indicates the unique identification number for the unit, the firmware version executing in the control unit, the status and activity of the control unit and the periods of time for which the control unit has caused electrical devices connected thereto to operate according to various DRM settings.

With reference to FIG. 7c, an alternative display is depicted in which the user has selected the Devices (490) sub-menu option of the display (400) thereby displaying in a the portion of the screen (492) a chart detailing installed units under the control of the user operating the display with a range of details including the unique identification number for the control unit, the geographic location of the control unit, the version of the firmware executing and controlling the control unit, the status of the control unit, the length of time for which the control unit has been in the “On” mode, and the period of time for which the control unit has caused devices connected thereto to operate in various DRM modes.

Throughout this specification and the claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as an acknowledgement, or any suggestion that, the prior art forms part of the common general knowledge.

1. An electrical power consumption control unit that controls power consumed by one or more electrical devices connected thereto the one or more electrical devices consuming power within one or more premises including a computer processor having a memory operably connected thereto storing computer instruction code, the unit further including:
a communication module operable to receive control signals from an energy manager external to the one or more premises requesting modification of power consumed by the one or more electrical devices;
a monitoring module operable to monitor power consumed by the one or more connected electrical devices; and
wherein the computer instruction code, when executed by the computer processor, causes the computer processor to:
control the supply of electrical power to the one or more electrical devices; and
transmit one or more notifications to the energy manager regarding the power consumed by the one or more connected electrical devices in response to the request thereby enabling the energy manager to confirm the success, or otherwise, of the request to modify power consumption.

2. An electrical power consumption control unit according to claim 1 wherein the control unit is operable to record power consumed by the one or more connected electrical devices over time.

3. An electrical power consumption control unit according to claim 2 wherein the measurement and recording of electrical power consumed is substantially continuous.

4. An electrical power consumption control unit according to claim 1, wherein the one or more notifications include the status of the requested modification to power consumed by the connected electrical devices.

5. An electrical power consumption control unit according to claim 1, wherein the requests regarding modification of power consumption include signals that cause the operating load of each of one or more connected electrical devices to be modified from x% to y% where x and y represent integers from zero to 100.

6. An electrical power consumption control unit according to claim 1, wherein the request regarding modification of electrical power consumed issued by an energy manager includes a request to activate the one or more connected electrical devices and/or deactivate the one or more connected electrical devices.

7. An electrical power consumption control unit according to claim 1, wherein the one or more notifications include a status of the current request regarding modification of electrical power consumption of the one or more connected electrical devices.

8. An electrical power consumption control unit according to claim 1, wherein the one or more notifications include data pertaining to an amount of electrical power consumed by the one or more connected electrical devices.

9. An electrical power consumption control unit according to claim 1, wherein the communication module is further operable to communicate with a plurality of power consumption control units installed within a premises wherein, the computer instruction code in each of the plurality of power consumption control units, when executed by the respective computer processor of each control unit, causes the computer processor to:
transmit contents of the computer memory of the control unit to the plurality of power consumption control units with which the control unit is within communication range; and
receive memory contents from the plurality of power consumption control units within which the control unit is in communication range.

10. An electrical power consumption control unit according to claim 9 wherein the memory contents of a control unit includes any one or more of the following:
the operational status of connected electrical devices at points in time;
the requested electrical power consumption modification at various points in time;
the electrical power consumption consumed by connected electrical devices at various points in time; or
a schedule of electrical power consumption for connected electrical devices in the future.

11. An electrical power consumption control unit according to claim 1, wherein a request from an energy manager includes a request to receive data from a control unit to receive stored data from a control unit pertaining any one or more of the following:
the operational status of connected electrical devices at points in time;
the requested electrical power consumption modification at various points in time;
the electrical power consumption consumed by connected electrical devices at various points in time; or
a schedule of electrical power consumption for connected electrical devices in the future.

12. A system for controlling power consumed by one or more electrical devices within one or more premises, the system including:
an energy manager external to the one or more premises requesting modification of power consumed by the one or more connected electrical devices; and
one or more electrical power consumption control units connected to the one or more electrical devices to which power is supplied from an electrical power grid, wherein each one of the one or more electrical power consumption control units include a computer processor having a memory operably connected thereto storing computer instruction code, the one or more units further including:
a communication module operable to receive control signals from the external energy manager;
a monitoring module operable to monitor power consumed by the one or more electrical devices;
wherein the computer instruction code, when executed by the computer processor, further causes the computer processor to:
control the supply of electrical power to the one or more connected electrical devices; and
transmit one or more notifications to the energy manager regarding the power consumed by the one or more connected electrical devices.

13. A method of controlling power consumed by one or more electrical devices within one or more premises, the method including installing, in the electrical supply line of the one or more electrical devices, one or more electrical power consumption control units including a computer processor having a memory operably connected thereto storing computer instruction code, the one or more units further including:
a communication module operable to receive control signals from an energy manager external to the one or more premises requesting modification of power consumed by the one or more electrical devices;
a monitoring module operable to monitor power consumed by the one or more electrical devices;
wherein the computer instruction code, when executed by the computer processor, causes the computer processor to:
control the supply of electrical power to the one or more connected electrical devices; and
transmit one or more notifications to the energy manager regarding the power consumed by the one or more connected electrical devices in response to the request thereby enabling the energy manager to confirm the success, or otherwise, of the request to modify power consumption.

14. A non-transitory computer readable medium including computer instruction code which, when executed by the processor of an electrical power consumption control unit having a computer processor and a memory operably connected thereto for storage of computer instruction code, a communication module operable to receive control signals from an energy manager and a monitoring module operable to monitor power consumed by one or more electrical devices within one or more premises connected to the electrical power consumption control unit, the computer instruction code when executed causing the electrical control unit to perform tasks including:
monitoring issued requests from the energy manager that is external to the one or more premises to adjust power consumption of the connected electrical devices; and
upon receipt of request, controlling the electrical power provided by the electrical power consumption control unit;
monitoring the actual electrical power consumed by the electrical devices connected to the electrical power consumption control unit; and
transmitting one or more notifications by the communication module to the energy manager regarding the actual power consumed by the one or more connected electrical devices in response to the request thereby enabling the energy manager to confirm the success, or otherwise, of the request to modify power consumption.
